(19) United States
(12) Patent Application Publication
(10) Pub. No.: US 2023/0018632 A1
(43) Pub. Date: Jan. 19, 2023

(54) METHODS AND ARRANGEMENTS FOR AN OCCUPANCY SENSOR

(71) Applicant: LEVITON MANUFACTURING CO., INC., Melville, NY (US)

(72) Inventors: Vikas Asthana, Tualatin, OR (US); Yuming Qin, Portland, OR (US); Raman Nair Harish Gopala Pillai, Portland, OR (US)

(73) Assignee: LEVITON MANUFACTURING CO., INC., Melville, NY (US)

(21) Appl. No.: 17/376,375

(22) Filed: Jul. 15, 2021

(51) Int. Cl. G01J 5/34; G01J 5/08

(52) U.S. Cl. CPC G01J 5/34; G01J 5/0803

(57) ABSTRACT

An occupancy sensor device may comprise a lens having a rated focal length, the lens to refract infrared radiation to converge at a point at the rated focal length; a passive infrared (PIR) sensor comprising detecting elements; and a body coupled with the lens and the PIR sensor to fix a distance between the lens and the PIR sensor, wherein the distance is less than a rated focal length of the lens and between the rated focal length of the lens and the lens, and the detecting elements of the PIR sensor are positioned to capture infrared radiation refracted by the lens. Some embodiments comprise a PIR sensor comprising an exposure area to capture infrared radiation incident to the exposure area; the PIR sensor comprising a first circuit board and a second circuit board coupled with the PIR sensor, the second circuit board perpendicular to the first circuit board.

### FIELD OF THE DISCLOSURE

The present disclosure relates generally to occupancy sensors and, more particularly, to a low profile, occupancy sensor with a wide field of view.

### BACKGROUND OF THE DISCLOSURE

Occupancy sensors that can operate as load controls, security devices, and/or the like. For instance, occupancy sensors may detect movement within a space in or around a building and responsively power one or more lights. Occupancy sensors may also or alternatively communicate with a processing system such as security system to indicate movement in or around spaces within or around a building.

Occupancy sensors can reduce power consumption of various loads that do not require power when a space is not occupied. For instance, some occupancy sensors are passive sensors that are low power devices that can form an electric charge from detection of motion such as some passive infrared (PIR) sensors. A PIR sensor may include, e.g., a pyroelectric sensor, a thermopile infrared sensor and a lens, or the like to detect changes in infrared radiation within a certain space or area about the PIR sensor.

Occupancy sensors may include a major motion PIR and a minor motion sensor such as an ultrasonic sensor and are typically rated by the field of view in degrees of motion detection and the area of motion detection at a range of mounting heights. The detection capabilities of PIRs relate to the viewing angle of the PIR and the detectable distance at which the PIR can detect motion.

### SUMMARY OF THE INVENTION

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Some embodiments include an occupancy sensor device. The occupancy sensor device may comprise a lens having a rated focal length, the lens to refract infrared radiation to converge at a point at the rated focal length; a passive infrared (PIR) sensor comprising detecting elements; and a body coupled with the lens and the PIR sensor to fix a distance between the lens and the PIR sensor, wherein the distance is less than a rated focal length of the lens and between the rated focal length of the lens and the lens and the detecting elements of the PIR sensor are positioned to capture infrared radiation refracted by the lens.

Further embodiments include an occupancy sensor device. The occupancy sensor device may comprise a lens having a rated focal length, the lens to refract infrared radiation to converge at a point at the rated focal length; a passive infrared (PIR) sensor comprising detecting elements with an exposure area, the exposure area to capture infrared radiation incident to the exposure area; a first circuit board comprising an opening for the exposure area of the PIR sensor in a primary plane of the first circuit board; a second circuit board coupled with the PIR sensor, the second circuit board having a primary plane perpendicular to the primary plane of the first circuit board and coupled with the first circuit board to position the exposure are of the PIR sensor in the opening; and a body coupled with the lens and the PIR sensor to fix a distance between the lens and the PIR sensor, wherein the distance is less than a rated focal length of the lens and between the rated focal length of the lens and the lens and the detecting elements of the PIR sensor are positioned to capture infrared radiation refracted by the lens.

### BRIEF DESCRIPTION OF THE DRAWINGS

By way of example, specific embodiments of the disclosed device will now be described, with reference to the accompanying drawings, in which:

FIG. 1 illustrates an embodiment of an occupancy sensor device comprising a dimming controller or digital addressable lighting interface (DALI) controller;

FIG. 2 illustrates another embodiment of an occupancy sensor device such as the occupancy sensor device shown in FIG. 1;

FIG. 3 illustrates an embodiment of an indicator to couple with the output of the occupancy sensor device in FIG. 2;

FIG. 4 illustrates an embodiment of a wireless communications circuit to couple with the output and/or input of the occupancy sensor device in FIG. 2;

FIG. 5 illustrates an embodiment of an actuator circuit to couple with the output of the occupancy sensor device in FIG. 2;

FIG. 6 illustrates an embodiment of an occupancy sensor device such as the occupancy sensor devices in FIGS. 1-5;

FIG. 7 illustrates an embodiment for an occupancy sensor device such as the occupancy sensor devices in FIGS. 1-6;

FIG. 8 illustrates another embodiment of a ceiling mount occupancy sensor device such as the occupancy sensor devices in FIGS. 1-7;

FIG. 9 illustrates an embodiment of a flowchart for the systems in FIG. 1-8;

FIG. 10 illustrates an embodiment of a storage medium such as the memory in FIGS. 1-2;

FIGS. 11A-11D illustrate multiple views of an embodiment for an occupancy sensor device such as the occupancy sensor devices in FIGS. 1-10;

FIG. 12 illustrates multiple views of an embodiment for an occupancy sensor device such as the occupancy sensor devices in FIGS. 1-11;

FIG. 13 illustrates multiple views of circuit boards and a PIR sensor for an embodiment of an occupancy sensor device such as the occupancy sensor devices in FIGS. 1-12;

FIG. 14 illustrates a cross-section of an alternative embodiment with varied mounting condition such as a thicker ceiling for a ceiling mount occupancy sensor device such as the occupancy sensor devices in FIGS. 1-13; and

FIG. 15 illustrates a cross-section of an alternative embodiment with varied mounting condition such as a thinner ceiling for a ceiling mount occupancy sensor device such as the occupancy sensor devices in FIGS. 1-14.

### DETAILED DESCRIPTION

Devices, systems, and methods in accordance with the present disclosure will now be described more fully hereinafter with reference to the accompanying drawings, in which preferred embodiments of the devices, systems, and methods are shown. The disclosed devices, systems, and method, however, may be embodied in many different forms and should not be construed as being limited to the embodiments set forth herein. Rather, these embodiments are provided so that this disclosure will be thorough and complete, and will fully convey the scope of the devices, systems, and methods to those skilled in the art. In the drawings, like numbers refer to like elements throughout.

Occupancy sensor devices may include a Fresnel lens, a passive infrared (PIR) sensor such as a pyroelectric sensor, one or more printed circuit boards, and a body. The Fresnel lens may have a single rated focal length or multiple rated focal lengths depending on the design and may refract infrared (IR) radiation or light, to converge the IR radiation over the rated focal length at a focal point. Contemporaneous occupancy sensors fix the distance between the lens and a PIR sensor at a rated focal length of the Fresnel lens to focus the incoming IR radiation on the PIR sensor.

Embodiments disclosed herein advantageously describe a low profile occupancy sensor with a wide coverage. For instance, a low profile occupancy sensor may include a body coupled with a lens and a PIR sensor to fix a distance between the lens and the PIR sensor, wherein the distance is, advantageously, less than a rated focal length of the lens. In many embodiments, the distance is also between the rated focal length of the lens and the lens and the detecting elements of the PIR sensor are positioned to capture infrared radiation refracted by the lens. Reduction of the focal length reduces the distance between the lens and the PIR sensor, advantageously simplifies construction of the occupancy sensor and may reduce the overall length of the occupancy sensor. In many embodiments, simplifying construction advantageously reduces costs of construction of the PIR sensor.

Embodiments may comprise a lens, such as a Fresnel lens, having a rated focal length to refract IR radiation. The lens may converge incident IR radiation at a focal point at the rated focal length (distance) from the lens. In some embodiments, the lens may have two or more focal lengths and, thus, two or more corresponding focal points.

Embodiments may include a PIR sensor comprising detecting elements. The detecting elements may include pyro-electric sensing elements and, in some embodiments, the detecting elements may comprise pyro-ceramic elements. The detecting elements may comprise a dual element, a quad element, or multiple elements (greater than four elements), and may generate a voltage, amperage, and/or a voltage and amperage signal based on incident IR radiation.

In some embodiments, the detecting elements are connected in series. In some of these embodiments, the elements are masked and connected in series to reduce noise associated with the detection elements and increase the detection of motion. The noise may include, for example, the average temperature, or IR radiation, of the field of view (FOV) of the occupancy sensor. The PIR sensor may also include circuitry to amplify and/or filter outputs from the detecting elements and, in some embodiments, convert the outputs from an analog format into a digital format via an analog to digital converter (ADC).

The detecting elements are exposed to IR radiation, in some embodiments via a clear or translucent protective layer, at one plane of the PIR sensor such as a top plane. The exposed detecting elements may form an exposure area at which the PIR sensor can collect IR radiation generated from a heat source or reflected by a surface towards the PIR sensor. The size and shape of the exposure area may be dependent on the size (or area of exposure) of the detecting elements, the configuration of the detecting elements such as the physical arrangement, and the number of the detecting elements in the PIR sensor.

Embodiments may also include a body coupled with the lens and the PIR sensor to fix a distance between the lens and the PIR sensor. The distance is, advantageously, distance is less than a rated focal length of the lens and between the rated focal length of the lens and the lens. In some embodiments, the distance is half the rated focal length. For example, an occupancy sensor may comprise a Fresnel lens with a single focal point at a 17 mm focal length and a quad element PIR with 0.8 millimeter (mm) by 0.8 mm elements arranged with 0.8 mm spacing in a 2.4 mm by 2.4 mm square exposure area. For a mounting height between 8 feet and 12 feet with a typical mounting height of 8.5 feet and a field of view of 1500 square feet, testing has confirmed that the PIR sensor may be mounted at half the rated focal length, or 8.5 mm, in the body of the occupancy sensor from the Fresnel lens without degradation of the rated parameters.

Depending on the rated parameters of the occupancy sensor and the PIR sensor such as the number of elements in the PIR, the size of the elements, the exposure area of the elements and the PIR sensor, the rated mounting height(s), the size of the lens, the configuration of the lens, and the rated field of view for the occupancy sensor; acceptable ranges of the fixed distance between the PIR sensor and the lens can be determined. Generally, the low profile occupancy sensor and advantages related thereto can be realized by mounting the PIR sensor at a distance less than the rated focal length of the lens. In some embodiments, the maximum advantages may be realized by reducing the distance between the PIR sensor and the lens to half the rated focal length or approximately half the rated focal length depending on tolerances of components selected to build (or construct) the occupancy sensor device. For instance, in some embodiments, the distance may be fixed at a distance between half the rated focal length and a quarter of the rated focal length of the lens without significant or any degradation in the rated parameters for the occupancy sensor. In some embodiments, the distance may be fixed at a distance between half the rated focal length and a third of the rated focal length of the lens without significant or any degradation in the rated parameters for the occupancy sensor. In further embodiments, the distance may be fixed at a distance between half the rated focal length and three quarters of the rated focal length of the lens without significant or any degradation in the rated parameters for the occupancy sensor. In still further embodiments, the distance may be fixed at a distance between half the rated focal length and two-thirds of the rated focal length of the lens without significant or any degradation in the rated parameters for the occupancy sensor. In some embodiments, the distance may be between 8.5 mm and the 17 mm focal length without significant or any degradation in the rated parameters for the occupancy sensor. In some embodiments, the distance may be between 7 mm and 8.5 mm with minor degradation with respect to the parameters discussed in the example above. And, in further embodiments, the distance may be fixed at a distance between 6 mm and 7 mm with some additional degradation.

The distance of the exposure area of the PIR sensor from the lens adjusts the size of the area upon which the IR radiation is incident on the exposure area of the PIR sensor. In some embodiments, the incident area of the IR radiation is within the exposure area of the PIR sensor. In other embodiments, the incident area of the IR radiation is larger than the exposure area of the PIR sensor. Incident areas larger than exposure area might cause some degradation in the field of view but may offer additional advantages related to the lower profile of the occupancy sensor and possibly shorter body length such as simplified construction and lower costs for the build.

The body may couple with the lens and the PIR sensor to position the detecting elements of the PIR sensor to capture IR radiation refracted by the lens. For instance, assuming the lens is designed to focus IR radiation at focal point in the center of the body, the body may couple the PIR sensor at the fixed distance from the lens at the center of the body to align the area of the IR radiation incident to the PIR sensor and the exposure area of the PIR sensor. In other words, the body may hold the PIR sensor at the fixed distance and positioned to align the area of the refracted IR radiation from the lens at the fixed distance with the exposure area of the PIR sensor.

Some embodiments include standalone occupancy sensor systems. Such systems may be configured to connect with one or more other devices through a wired connection or through a wireless connection. In some embodiments, a circuit board of the PIR sensor may comprise a wireless communication interface and implement one or more wireless communication protocols such as a Wi-Fi communications protocol, a Bluetooth communications protocol, a ZigBee communications protocol, a Z-Wave communications protocol; a cellular communications protocol, and/or any Institute of Electrical and Electronics Engineers (IEEE) 802.15.4 standard based protocol.

In further embodiments, a circuit board of the occupancy sensor device may include a Digital Addressable Lighting Interface (DALI). The circuit board may include a DALI controller and wireless or wired connections for one or more DALI enabled lighting devices. A DALI network consists of at least one controller and bus power supply as well as input devices (e.g. sensors and push-buttons), control gear (e.g., electrical ballasts, LED drivers and dimmers) with DALI interfaces. Controllers can control, configure or query each device by means of a bi-directional data exchange. The DALI protocol permits addressing devices individually, in groups or via broadcast.

Several embodiments communicate via one or more wireless communication protocols such as Bluetooth or Bluetooth Low Energy in accordance with, e.g., the Bluetooth Core Specification v5.0 published Dec. 6, 2016, Bluetooth Mesh, Near Field Communication, Zigbee or Z-wave, one or more cellular communication standards such as one or more 3rd Generation Partnership Project (3GPP), 3GPP Long Term Evolution (LTE), 3GPP LTE-Advanced (LTE-A), 4G LTE, and/or 5G New Radio (NR), technologies and/or standards, one or more infrared communication protocols, etc. Further embodiments implement one or more IEEE 802.11 standards (sometimes collectively referred to as “Wi-Fi”). Such standards may include, for instance, the IEEE 802.11-2020, published Dec. 3, 2020. Some embodiments implement the IEEE standards in accordance with a Wi-Fi Alliance specification such as the Wi-Fi Peer-to-Peer (P2P) technical specification version 1.7, published Jul. 6, 2016. Some embodiments implement a combination of one or more protocols of one or more of the standards and/or specifications. The embodiments are not limited to these standards and specifications.

Some embodiments include an occupancy sensor that is integrated with an actuator, which is a controllably conductive device such as one or more switches, relays, power transistors, capacitive touch sensors, capacitive switches, or the like. In such embodiments, the occupancy sensor may couple with the same printed circuit board (PCB) as the actuator. In some embodiments, the PCB with the occupancy sensor may be contained in a housing such as a light switch housing or a ceiling mount housing that is adapted for installation partially in and/or attached to an electrical junction box. In some embodiments, the actuator may turn on or power the luminaire, e.g., by activating a coil in a relay of the ballast or by activating a channel of a power transistor in the ballast of the luminaire. The actuator may turn off the luminaire, e.g., by deactivating a coil in a relay of the ballast or by deactivating a channel of a power transistor of the ballast of the luminaire.

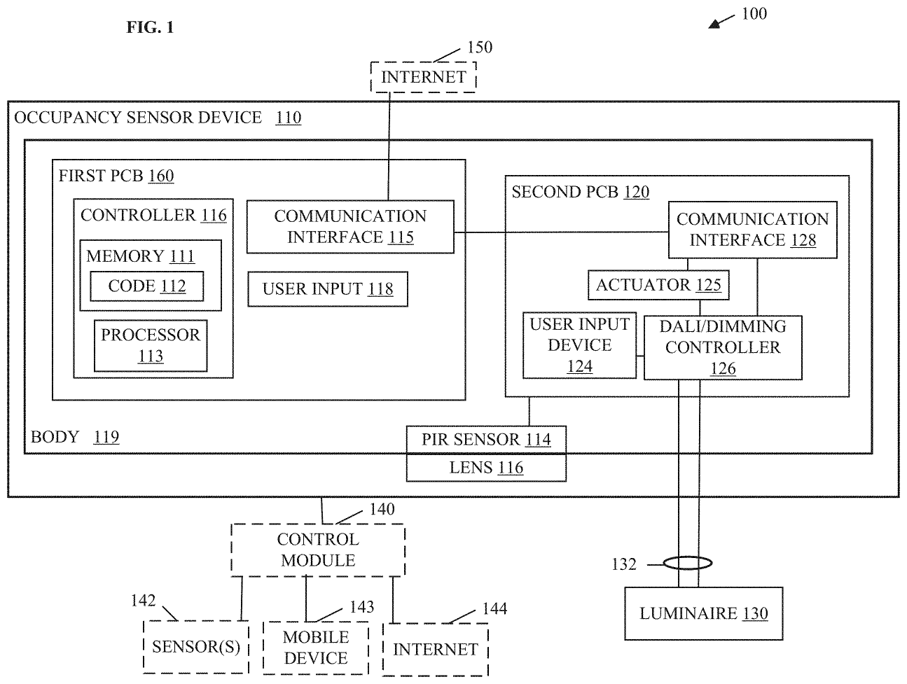

FIG. 1 illustrates an embodiment of a system 100 including an occupancy sensor device 110 coupled with a luminaire 130 and an optional control module 140. In the present embodiment, the occupancy sensor device 110 includes a first printed circuit board (PCB) 160 and a second PCB 120 housed within a body 119.

The occupancy sensor device 110 may be a low profile occupancy sensor with a wide coverage. The occupancy sensor device 110 may be a processor-based device that includes a PIR sensor 114, a lens 116, and other circuitry to detect IR radiation within the vicinity of the occupancy sensor device 110 such as a field of view of a 2000 square foot area about the occupancy sensor device 110. In other embodiments, the occupancy sensor device 110 may be rated for a 450 square foot area, a 1000 square foot area, a 1500 square foot area, an 1800 square foot area, or the like. The ratings are typically based on a particular mounting, such as a ceiling mount or a wall mount, at a particular height or range of heights, such 8 feet to 15 feet or 20 to 40 feet.

The body 119 may comprise any low profile shape adapted to contain the occupancy sensor device 110 and maintain the relative positions of the PIR sensor 114 and the lens 116 to fix the distance between an exposure area on the PIR sensor 114 and the lens 116. The body 119 may also be adapted for specific installations such as attachment to a ceiling mount, attachment to a light fixture, attachment to an electrical switch for a light fixture or other electronic device, and/or the like.

In the present embodiment, the controller 116 of the occupancy sensor device 110 may include logic circuitry such as memory 111 and a processor 113 to execute code 112 in the memory 111. The code 112 may comprise one or more applications to, e.g., control lighting such as applications to communicate with a DALI/dimming controller 126, communicate an emergency signal with the actuator 125, set themes or moods for lighting, adjust lighting based on time of day or season, adjust lighting based on sensor input or communications with a control module 140, and/or the like. In other embodiments, the logic circuitry may include circuitry such as state machines, logic gates, application specific integrated circuits (ASICs), field programmable gate arrays (FPGAs), other circuitry, or the like. The controller 116 may be programmed via the code 112, or otherwise configured, to analyze, evaluate, and adjust sensitivity and time delay to reduce false triggers related to ambient or environmental conditions such as temperature, daylight, rain, and the like continually or periodically. In some embodiments, the controller 116 may be programmed via the code 112, or otherwise configured, to determine whether an output from the PIR sensor 114 relates to a detection of motion or relates to a false trigger responsive to other environmental factors. For instance, the occupancy sensor device 110 may comprise a pet-friendly motion detector that excludes motion of small pets as false triggers.

The occupancy sensor device 110 may have preset threshold settings to adjust the sensitivity of the occupancy sensor device 110. The occupancy sensor device 110 may automatically select a preset threshold setting, for example, based on the time of day. In some embodiments, the occupancy sensor device 110 may comprise a user input 118 such as a switch or a slide bar, or other actuator, to allow a user to physically select a sensitivity of the occupancy sensor device 110. Setting the sensitivity may select or adjust one or more preset thresholds designated for analyzing the output signal of the PIR sensor 114. For instance, in some embodiments, the controller 116 may include a preset threshold and may be programmed to compare the preset threshold against a magnitude of the output signal from the PIR sensor 114. If the magnitude of the amplitude of one or more pulses from the PIR sensor 114 exceed the threshold, the output signal may represent a detection event of motion by the PIR sensor 114. On the other hand, if the magnitude of the amplitude of one or more pulses from the PIR sensor 114 are less than the preset threshold, the output signal may represent a false trigger by the PIR sensor 114.

The PIR sensor 114 and the lens 116 may be coupled with the body 119 to maintain a specific distance between an exposure area of the PIR sensor 114 and the lens 116 such as a distance that is less than the rated focal length of the lens. In some embodiments, the body 119 may position the exposure area of the PIR sensor 114 at half the rated focal length of the lens 116 and may align the exposure area of the PIR sensor 114 with an area on the PIR sensor 114 of IR radiation refracted through the lens 116. For instance, when IR radiation passes through the lens 116 from the air about the occupancy sensor device 110, the change in the medium through which the IR radiation passes will change the speed of the IR radiation, which causes the reflection of the IR radiation and a refraction of the IR radiation. The same occurs when the IR radiation reaches the medium interface such as air at the bottom of the lens 116, i.e., the IR radiation is split into a reflection component and a refraction component. In addition, many lenses such as Fresnel lenses include features of the top and/or bottom surfaces of the lenses to direct a second refracted component of the IR radiation (the refracted component that enters the interior of the occupancy sensor device 110 after passing through the lens 116) towards a focal point of the lens 116. The distance between the lens and the focal point is the rated focal length. Note that the “second refracted component” is defined herein as the refracted component that exits the lens 116 and enters the medium at the underside of the lens 116 because a lens design may cause more than two refractions.

The second refracted components of each ray of IR radiation incident to the lens 116 may converge towards the rated focal point but the PIR sensor 114, being located between the focal point and the lens 116, will receive a set of rays of the IR radiation in the process of converging, or partially converged. When the partially converged IR radiation is incident on the surface or top plane of the PIR sensor 114, the partially converged IR radiation is incident to the PIR sensor 114 at an area larger than the area would be for the converged IR radiation at the focal point.

When the area of incidence of the second refracted components of the IR radiation is aligned with the area of exposure on the PIR sensor 114, the PIR sensor 114 can advantageously capture the IR radiation needed to identify motion. If the area of incidence of the second refracted components of the IR radiation is within the area of exposure on the PIR sensor 114, the PIR sensor 114 may capture a high enough percentage (e.g., 100%) of the IR radiation to maintain rated performance of the occupancy sensor device 110. If the area of incidence of the second refracted components of the IR radiation is larger than the area of exposure on the PIR sensor 114, the PIR sensor 114 may also capture a high enough percentage of the IR radiation to maintain rated performance of the occupancy sensor device 110. Degradation of the performance of the PIR sensor 114 depends on a number of factors in addition to the size of the area of IR radiation incident on the PIR sensor 114 such as the sensitivity of the detecting elements such as thermocouples or pyro-ceramic elements of the PIR sensor 114, the rated parameters of the occupancy sensor device 110, the design of the lens 116, and the like.

The occupancy sensor device 110 may also comprise a communication interface 115 to communicate an indication of a motion from the second PCB 120 to the first PCB 160. In some embodiments, the communication interface 115 may comprise connection points to interconnect the occupancy sensor device 110 with the communication interface 128 of the second PCB 120. The connection points may include power and communication signals such as DALI communications or dimmer control communications to/from the DALI/dimming controller 126, an emergency sense signal, PIR sensor communications, and/or the like. In such embodiments, the communication interface 115 and communication interface 128 may comprise one or more circuit board connectors and/or conductors to interconnect such communications and power between the first PCB 160 and the second PCB 120. In some embodiments, the one or more circuit board connectors and/or conductors may comprise soldered connections. In some embodiments, the PIR sensor 114 may reside on the second PCB 120 and the top of the PIR sensor 114 may be located in an opening of the first PCB 160. In such embodiments, the body 119 may couple with the first PCB 160 and/or the second PCB 120 to fix the distance between the PIR sensor 114 and the lens 116. In other embodiments, the controller 116 may reside on the same PCB as one or more of the components of the second PCB 120.

In further embodiments, the communication interface 115 comprises a wireless communications interface capable of wirelessly communicating with a wireless communications interface of the luminaire 130 via one or more wireless communication protocols such as Bluetooth, Wi-Fi, ZigBee, Z-Wave, or the like. The communication interface 115 may include one or more transceivers to accommodate wireless communication with devices and, possibly cloud service platforms, over a variety of wireless communication standards or protocols. In some embodiments, the communication interface 115 may comprise an antenna such as wire antenna located on the first PCB 160 and/or the second PCB 120 and, in other embodiments, the communication interface 115 may couple with an antenna such as an array of antenna elements.

In some embodiments, the communication interface 115 comprises a wireless communications interface capable of wirelessly communicating with a communications interface of a light fixture, the controller module 140, a mobile device 143, the Internet 150, or other computer via one or more wireless communication protocols such as Bluetooth, Wi-Fi, 4G, LTE, 5G, and/or any known wireless communication standard or protocol. Example wireless protocols may include, for example, Wi-Fi (e.g., any IEEE 802.11 a/b/g/n network); a Personal Area Network (PAN) such as Bluetooth, Bluetooth Low Energy, or Bluetooth Mesh; Near Field Communication; a mesh network such as Zigbee or Z-wave; any cellular communication standard; any infrared communication protocol; etc. In such embodiments, the mobile device 143 may set the sensitivity of the occupancy sensor device 110 remotely via an application executing on the mobile device 143.

In some embodiments, the occupancy sensor device 110 may comprise a system-on-a-chip (SoC) or a chip package with multiple integrated circuits. In other embodiments, one or more of the memory 111 storing the code 112, the PIR sensor 114, the communication interface 115, and the controller 116 may reside in distinct chips and be interconnected via one or more circuit boards and/or conductors.

In other embodiments, the communications interface 115 may communicate with a control module 140. The control module 140 may be, e.g., a hub, a gateway, a site controller, a combination thereof, or the like. For example, the PIR sensor 114 may generate an output signal responsive to motion detection and wirelessly communicate the indication to the control module 140. The control module 140 may respond by instructing the controller 116 to apply power to the load connected to the second PCB 120 such as the luminaire 130. In some embodiments, such as embodiments that implement a DALI bus via the DALI/dimming controller 126, the luminaire 130 may represent multiple lighting fixtures with DALI interfaces.

The control module 140 may couple with one or more sensors 142 and may couple with the Internet 144. In many embodiments, an application in the code 112 and executed by the processor 113 may communicate with the control module 140 and/or the occupancy sensor device 110 to receive an indication of a motion detection and determine appropriate changes to the luminaire 130 in accordance with settings for the DALI/dimming controller 126. In several embodiments, the control module 140 may include clock circuitry to maintain a time of day as well as astronomical clock circuitry to adjust and intensity of the luminaire 130 for local sunrise and sunset times. For embodiments with access to the Internet, the control module 140 may periodically update or verify the accuracy of the clock circuitry and/or the astronomical clock circuitry.

The second PCB 120 may be an electrical device to generate control signals 132 based on a user input via the user input device 124 to control an attribute of a load such as the luminaire 130. The second PCB 120 may comprise a dimming controller 126 and a communications interface 128. The second PCB 120 may interact with the occupancy sensor device 110 directly via the communication interface 128.

In some embodiments, the second PCB 120 may comprise an actuator 125 to receive emergency signal from remote device and the processor 113 processes the signal and instructs the luminaire 130 connected to emergency power supply. In some embodiments, the actuator 125 may hold load level to maximum output when a normal alternating current (AC) power supply gone signal is asserted by the processor 113. The actuator 125 may restore to actual dimming level when the AC power supply is available or when a normal AC power supply gone signal is no longer asserted by the processor 113. In some embodiments, the actuator 125 may disconnect power from the dimming controller 126. In other embodiments, the actuator 125 may provide an input to the dimming controller 126 that reduces the duty cycle of the output signals 132 to zero percent or otherwise reduces the power to the luminaire 130 to effectively turn off the luminaire 130. In other embodiments, the actuator 125 may be located in a remote device.

In some embodiments, the user input device 124 may comprise a tactile actuator to control dimming of the luminaire 130 via the dimming controller 126. The user may activate the tactile actuator to instruct to the dimming controller 126 to adjust a first attribute of the load by increasing the intensity level of the light generated by the luminaire 130. The user may activate the tactile actuator for few seconds to activate different user-defined dimming levels or test features for the luminaire 130. In other embodiments, the user input device 124 may reside in a remote devices.

The control signals 132 may be any type of signals that can communicate values for the intensity level and the color temperature to the luminaire 130 or a ballast for the luminaire 130. In some embodiments, the control signals 132 comprise pulse-width modulation (PWM) control signals. In many embodiments, the control signals 132 may cycle the luminaire on and off in accordance with the duty cycle to establish the intensity level of light and/color temperature emitted from the luminaire 130 via, e.g., a relay and/or power transistor in the second PCB 120 or in the luminaire 130 or a ballast for the luminaire 130. For example, in response to detection of motion by the occupancy sensor device 110 in a hallway of a building, the occupancy sensor device 110 may output an indication of the detection of motion to the communication interface 128 of the second PCB 120 associated with the hallway. The second PCB 120 may turn on the luminaire 130 or adjust the intensity and/or color temperature of the luminaire 130 in response to the detection of motion in the hallway.

The communication interface 128 may comprise one or more connectors and/or conductors to connect the PCB 120 with the PCB 160 to facilitate communication with the processing device 113. For example, the communication interface 128 may comprise two board-to-board connectors to connect an emergency signal a ground, a 3.3 volt direct current (VDC) supply, a 5 VDC supply, a pulse-width modulation signal for dimming control by the DALI/dimming controller 126, and PIR signals. In some embodiments, the communication interface 128 may connect a DALI transmit and a DALI receive signal for communication between the processor 113 and the DALI/dimming controller 126 to control DALI lighting.

The controller 116 and the control module 140 may communicate wirelessly over any frequency within any licensed or unlicensed frequency band (e.g., over a 900 MHz operating frequency band, a 2.4 GHz operating frequency band, a 5 GHz operating frequency band, or a 6 GHz operating frequency band). The occupancy sensor device 100 may implement any known security or encryption protocol or standard such as, for example, WPA or WPA2, to communicate, either directly or indirectly, with other devices over a wireless connection and/or through one or more intermediate devices (such as, for example, a cellular base station, a Wi-Fi router, a cloud service platform, etc.).

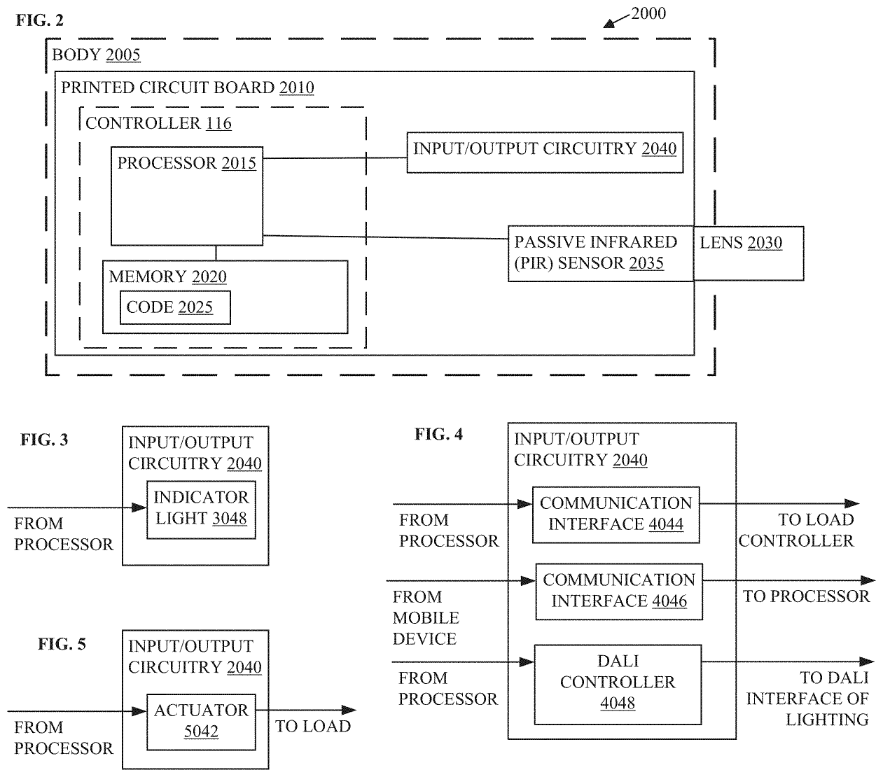

FIG. 2 illustrates an embodiment of an occupancy sensor device 2000 on a PCB 2010 such as the occupancy sensor device 110 shown in FIG. 1. The PCB 2010 may comprise circuitry and/or conductors interconnecting the controller 116, an PIR sensor 2035, and input/output (I/O) circuitry 2040. A body 2005 may enclose the occupancy sensor device PCB 2010 and facilitate exposure of a lens 2030 to an exterior of the body 2005 to capture IR radiation. In some embodiments, the body 2005 couples to the PCB 2010 and couples directly to the lens 2030 or directly to a connector that holds the lens 2030 in a fixed position relative to the PIR sensor 2035. In other embodiments, the body 2005 couples to the PCB 2010 and the lens 2030 couples with the PCB 2010. In many embodiments, the body 2005 may comprise a non-conductive material such as a plastic to avoid interference with wireless communications from the PCB 2010 to one or more remotes devices that are exterior to the body 2005.

The controller 116 may include a processor 2015 and supporting circuitry for the processor 2015 such as a clock circuit, one or more voltage supplies at one or more voltages, gates, buffers, amplifiers, an analog-to-digital converter (ADC), a DALI controller coupled with a DALI bus power supply, and/or the like. The processor 2015 may also comprise a memory 2020 coupled with the processor 2015 and the memory 2020 may comprise code 2025 to distinguish motion detection from false triggers. In some embodiments, the processor 2015 may execute code to automatically update a sensitivity setting on a periodic or continual basis. The processor 2015 may execute code such as the code 2025 in the memory 2020.

During execution of the code 2025, the processor 2015 may place the occupancy sensor device 2000 into a low power mode until first detection of an output signal from the PIR sensor 2035. If the output signal indicates a detection of motion, the processor 2015 may execute the corresponding code 2025 to return the occupancy sensor device 2000 to a normal power usage level.

The lens 2030 may comprise a Fresnel lens, a short focal length lens, or any other lens capable of refracting IR radiation to a focal point. The PIR sensor 2035 may comprise an exposure area to expose detecting elements to IR radiation incident to the lens 2030 for capturing IR radiation refracted via the lens to the exposure area of the PIR sensor. In some embodiments, the PIR sensor 2035 may comprise a dual element PIR sensor or quad element PIR sensor. In some embodiments, the exposure area of the dual element PIR sensor may be smaller than the exposure area of the quad element PIR sensor. In other embodiments, the exposure area of the dual element PIR may be larger than the quad element PIR. In some embodiments, the exposure area of the dual element is not square. For instance, the exposure area of 2 mm×1 mm detecting elements with a 1 mm spacing may be 4 mm×3 mm (which is larger than the 2.4 mm×2.4 mm quad elements discussed above).

Based on the convergence characteristics of the lens 2030 and the configuration of the PIR sensor 2035, the exposure area can be aligned to the incident area of the IR radiation refracted by the lens 2030 on to the PIR sensor 2035 to capture the IR radiation. The body 2005 may couple with the PIR sensor 2035 and the lens 2030 either directly or via a connection with the PCB 2010 to fix the distance between the PIR sensor 2035 and the lens 2030, wherein the distance is less than the rated focal length of the lens 2030 to advantageously create a low profile occupancy sensor device with a wide field of view.

FIG. 3 illustrates an example of the input/output circuitry 2040 comprising a visible indicator such as an indicator light 2048, an audible indicator device (not shown), and/or an audible indicator device integrated with the indicator light 2048 to output an audible indicator. In some embodiments, the indicator light may include a single color light, such as red, to provide a visual indication of detection of motion when the output signal from the PIR sensor 2035 is determined by the processor 2015 to be an output signal responsive to detection of motion.

The input/output circuitry 2040 may include one or more transistors, buffers, gates, amplifiers, and/or filters in addition to the indicator light 3048 as shown in FIG. 3, an audible indicator device (not shown), a communication interface 4044 shown in FIG. 4, a communication interface 4046 shown in FIG. 5, an actuator 5042 shown in FIG. 5, and/or a combination thereof.

FIG. 4 illustrates an example of the input/output circuitry 2040 comprising a communication interface 4044 to transmit an indication of the output of the PIR sensor 2035 to a load controller to power a load in response to a determination by the processor 2015 that the output signal from the PIR sensor 2035 indicates detection of motion. The input/output circuitry 2040 may also comprise a communication interface 4046 to receive a transmission from a mobile device or other computer and to pass the information from the transmission to the processor 2015. For instance, the mobile device may transmit a packet including a setting or configuration for the occupancy sensor device 2000 such as a sensitivity setting for the PIR sensor 2035 and the processor 2015 may store the setting or configuration in an appropriate location in the memory 2020 to implement the setting or configuration.

In some embodiments, the input/output circuitry 2040 may comprise a DALI controller 4048 to transmit and receive communication with a DALI interface of one or more luminaires. For instance, the DALI controller 4048 may control all the main lighting fixtures in an area such as a room to control the intensity levels and colors of the all the main lighting fixtures.

FIG. 5 illustrates an example of the input/output circuitry 2040 comprising an actuator 5042 such as the actuator 125 in FIG. 1. In some embodiments, may receive emergency signal from remote device and send control signal to a load in response to an output from the processor 2015 such as a signal for dimming to maximum level on a lighting load connected to emergency power supply.

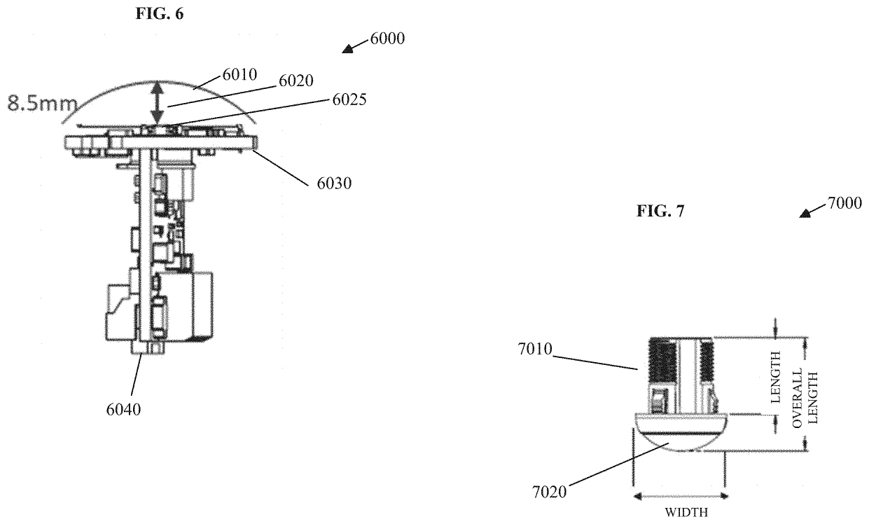

FIG. 6 illustrates an embodiment of an occupancy sensor device 6000 such as the occupancy sensor devices 110 and 2000 described in conjunction with FIGS. 1-2. The occupancy sensor device 6000 is illustrated without a body but a body that fixes the distance 6020 (such as 8.5 mm) between the lens 6010 and the exposure area 6025 of the PIR sensor can create the occupancy sensor device 6000 as a low profile occupancy sensor device. In some embodiments, the distance 6020 may be half the rated focal length of the lens 6010. In further embodiments, the distance 6020 may be less than the rated focal length of the lens 6010.

The occupancy sensor device 6000 includes a first PCB 6030 coupled with a second PCB 6040 such that the primary plane (horizontal across the view) of the first PCB 6030 is perpendicular to the primary plane (vertical through the view) of the second PCB 6040.

FIG. 7 illustrates an embodiment of an occupancy sensor device 7000 such as the occupancy sensor devices 110, 2000, and 6000 described in conjunction with FIGS. 1-2 and 6. The occupancy sensor device 7000 is illustrated with a threaded body that fixes the distance (such as half the rated focal length of the lens 7020) between the lens 7020 and the exposure area of the PIR sensor (not shown) to build the occupancy sensor device 7000 as a low profile occupancy sensor device. In some embodiments, the distance may be between the lens 7020 and the PIR sensor is between half the rated focal length of the lens 7020 and three quarters of the rated focal length of the lens 7020. In some embodiments, the distance may be between half the rated focal length of the lens 7020 and two thirds of the rated focal length of the lens 7020.

In some embodiments, the occupancy sensor device 7000 may have an overall length of 37.36 mm, a body length of 25.15 mm, and a maximum width of 30.01 mm. Such embodiments may, for instance, have a major motion (IR radiation) field of view of 1800 square feet and a minor motion (ultrasonic radiation) field of view of 800 square feet when the occupancy sensor device 7000 is mounted at a height of 8.5 feet.

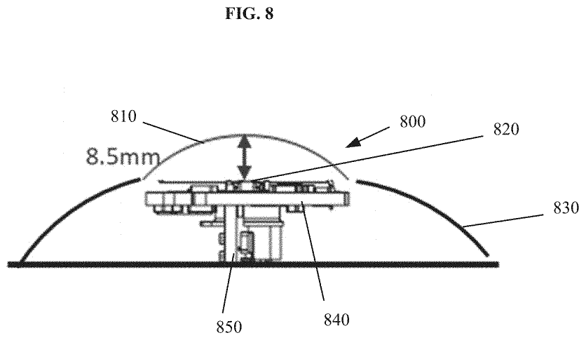

FIG. 8 illustrates another embodiment of a ceiling mount or wall mount occupancy sensor device 800 such as the occupancy sensor devices 110, 2000, 6000, and 7000 described in conjunction with FIGS. 1-7. The occupancy sensor device 800 includes a body 830 to position the lens 810 at a fixed distance (such as 8.5 mm) from an exposure area 820 of a PIR sensor. The occupancy sensor 800 includes a first PCB 840 and a second PCB 850 coupled such that the first PCB 840 is perpendicular to the second PCB 850. In some embodiments, the fixed distance is between half the rated focal length and a third of the rated focal length of the lens. In some embodiments, the fixed distance is between half the rated focal length and a quarter of the rated focal length of the lens 810. In some embodiments, the fixed distance is half the rated focal length.

FIG. 9 illustrates an embodiment of a flowchart 900 for an occupancy sensor device such as the occupancy sensor device 110 in FIG. 1 and the occupancy sensor device 2000 in FIG. 2. The flowchart begins at element 910 with monitoring, by a controller of the occupancy sensor device (such as the controller 116 in FIGS. 1 and 2), for an output of a first pulse from a PIR sensor. At element 915, the controller may receive a first pulse from the occupancy sensor and the controller may determine if the first pulse does not correspond with a detection of motion at element 920. If the first pulse does not correspond to a detection of motion, the controller may determine that the output from the PIR sensor is a false trigger and return to monitoring the outputs of the sensors at element 910, or optionally enter a low power mode at element 930.

If the output from the PIR sensor does correspond with motion detection, the controller may determine that the output from the occupancy sensor indicates a detection of motion (element 920). In response, the controller may output an indication of motion (element 925) to the output circuitry and optionally enter a low power mode (element 930).

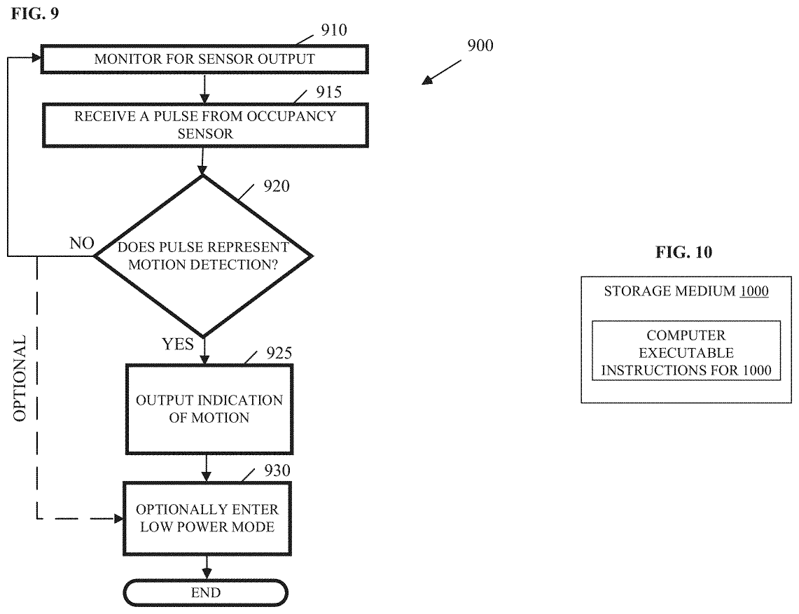

FIG. 10 illustrates an example of a storage medium 1000 to store code such as the code 112 and 2025 shown in FIGS. 1-2. Storage medium 1000 may comprise an article of manufacture. In some examples, storage medium 1000 may include any non-transitory computer readable medium or machine-readable medium, such as an optical, magnetic or semiconductor storage. Storage medium 1000 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

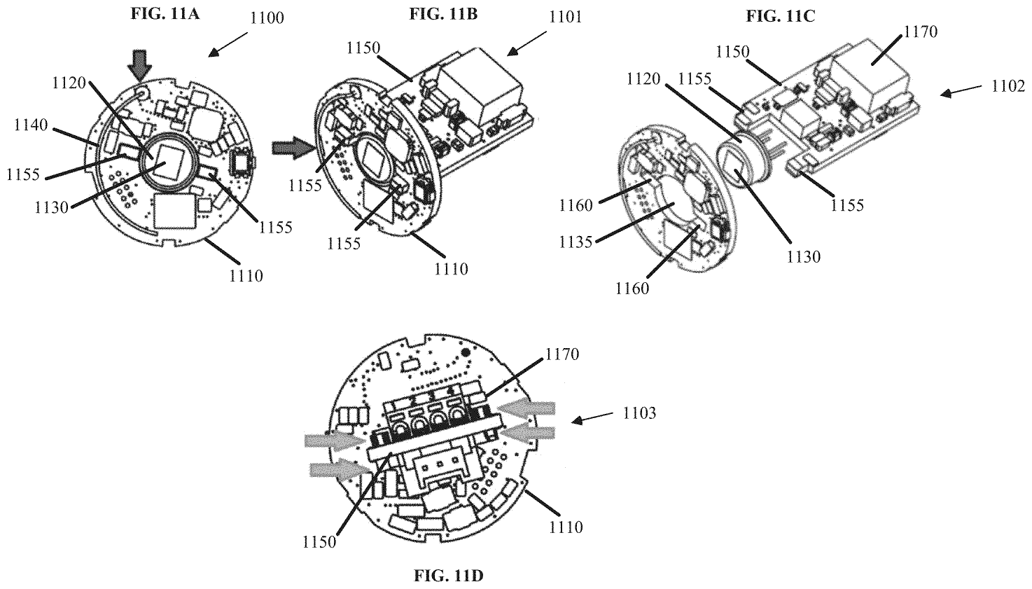

FIGS. 11A-D illustrates an example of an occupancy sensor device without a body. FIG. 11A illustrates a top view 1100 of a first PCB 1110 of the occupancy sensor device. The first PCB 1110 has a PIR sensor 1120 in an opening 1135 (illustrated in FIG. 11C) of the first PCB 1110. The PIR sensor 1120 includes an exposure area 1130.

The first PCB 1110 also includes an antenna 1140 along with other circuitry such as a processor, a wireless communications interface, memory, an on/off switch and/or a reset switch, a light emitting diode that emits light in response to detection of motion, a photocell, or a subset thereof.

The first PCB 1110 may comprise notches 1160 (shown in FIG. 11C) in the opening 1135 (shown in FIG. 11C) to couple with connectors 1155 of a second PCB 1150 (shown in FIGS. 11B-D). In some embodiments, the connectors 1155 may be soldered to the first PCB 1110 to provide stability and/or to interconnect power from the second PCB 1150 with the first PCB 1110.

FIG. 11B illustrates an angled view 1101 of the occupancy sensor device that illustrates a side view and top view of the first PCB 1110 and the second PCB 1150. The first PCB 1110 is coupled with the second PCB 1150 via the connectors 1155 such that a primary plane of the PCB 1110 is perpendicular to a primary plane of the second PCB 1150.

FIG. 11C illustrates an angled view 1102 of the occupancy sensor device that illustrates a side view and top view of the first PCB 1110 and the second PCB 1150. The angled view 1102 is similar to the angled view 1101 but the PCB 1110 is not connected to the PCB 1150 via the connectors 1155 in the notches 1160 and the PIR sensor 1120 is not connected to the PCB 1150 or within the opening 1135 of the first PCB 1110. The first PCB 1110 comprises wire terminals 1170 to connect with wires to interconnect, e.g., a light fixture with the occupancy sensor device.

FIG. 11D illustrates a bottom view 1103 of the occupancy sensor device looking towards the bottom of and the second PCB 1150 and the bottom of the first PCB 1110. The bottom view 1103 shows a bottom view of the wire terminals 1170.

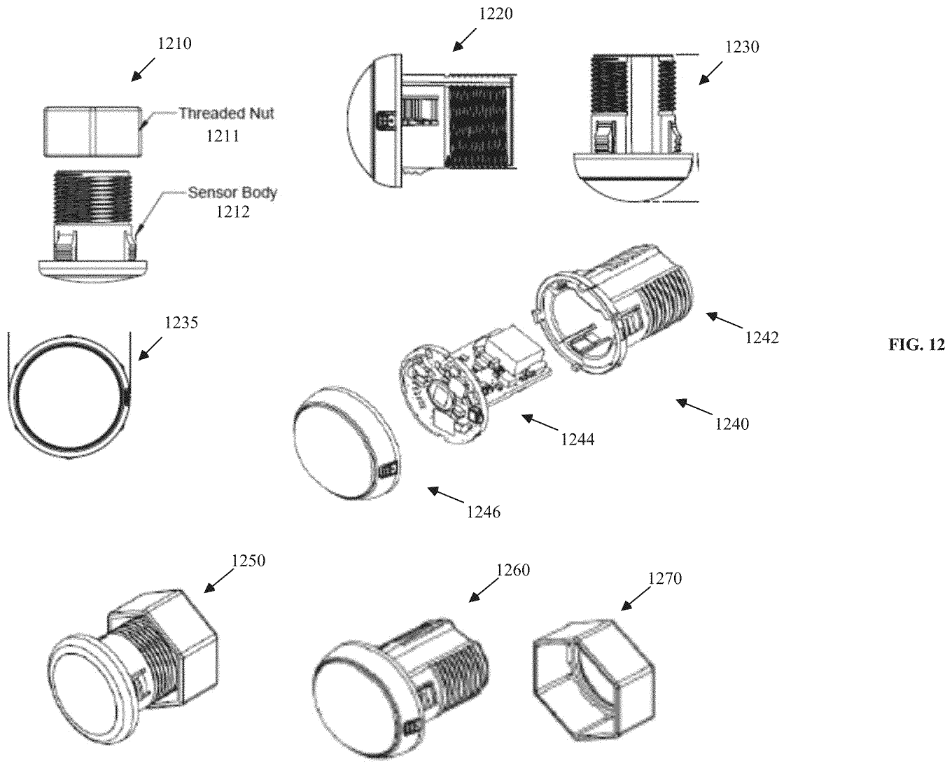

FIG. 12 illustrates multiple views of an occupancy sensor device with a nut mount such as the occupancy sensor devices 110, 2000, 6000, and 7000 described in conjunction with FIGS. 1-11. View 1210 of the occupancy sensor device illustrates a side view with the top facing down. The view 1210 includes a threaded nut 1211 that is configured to attach to a threaded sensor body 1212. View 1220 illustrates another side view of the occupancy sensor device with a top facing right and view 1230 shows another side view of the occupancy sensor device with the top facing down.

View 1235 shows a top view of the occupancy sensor device with the lens being the only visible part. View 1240 illustrates an angled view of the occupancy sensor device that illustrates a top view and a side view. The view 1240 shows separated components of the occupancy sensor device including the lens 1246, the first and second PCBs interconnected, and the threaded body 1242.

View 1250 illustrates an angled view of the occupancy sensor device that illustrates a top view and a side view of the occupancy sensor device fully assembled with the lens, the body, and the nut being visible. View 1260 illustrates an angled view of the occupancy sensor device that illustrates a top view and a side view of the occupancy sensor device fully assembled with the lens and the body but without the threaded mounting nut. And view 1270 illustrates an angled view of the mounting nut for the occupancy sensor device.

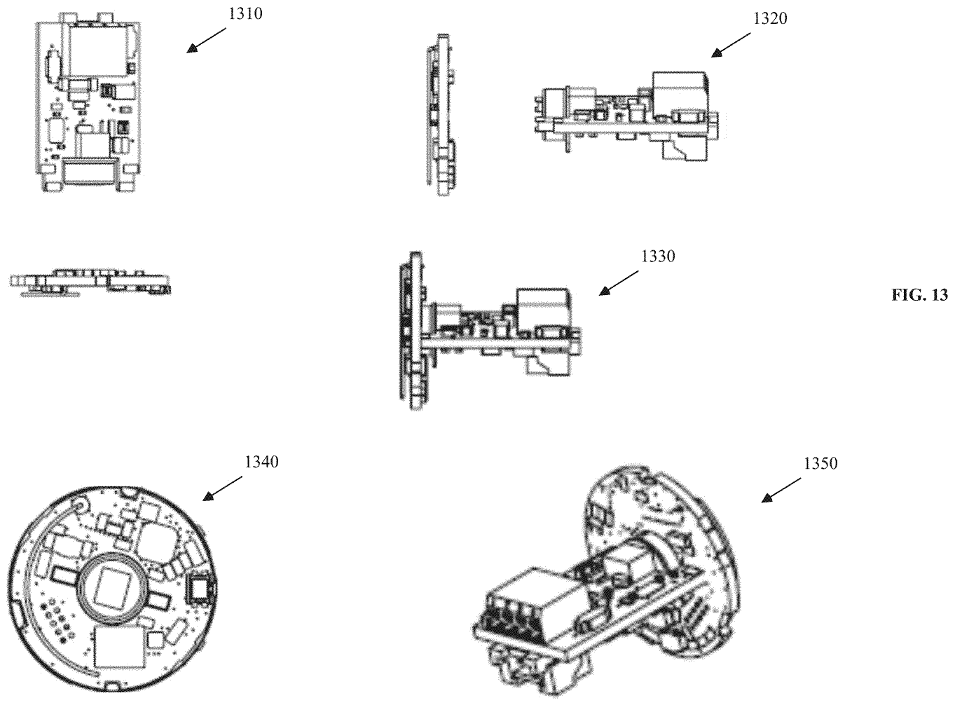

FIG. 13 illustrates multiple views of the first PCB and the second PCB of an occupancy sensor device without a body such as the first and second PCBs 1110 and 1150 described in conjunction with FIGS. 1-12. View 1310 illustrates a side view with the top facing down. View 1320 illustrates another side view of the occupancy sensor device with a top facing right.

Views 1330 through 1350 add the PIR sensor and connect the first PCB and the second PCB with the primary plane of the first PCB being perpendicular to the primary plane of the second PCB. View 1330 illustrates a side view of the first and second PCBs interconnected with a top facing right. View 1340 depicts a top view of the first and second PCBs interconnected. And view 1350 depicts an angled view that illustrates the bottom view and the side view of the first and second PCBs interconnected.

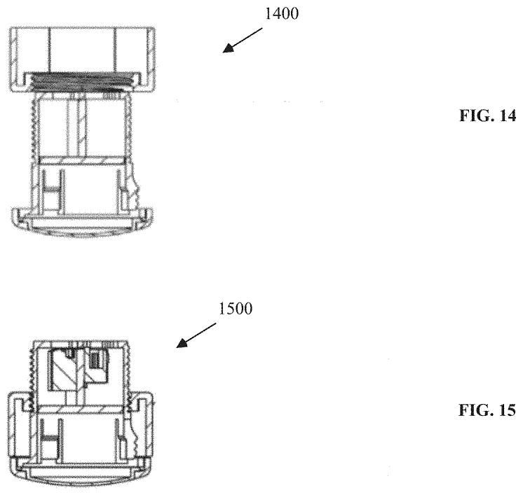

FIG. 14 illustrates a cross-section 1400 of a side view of an occupancy sensor device with the top facing down such as the occupancy sensor devices 110, 2000, 6000, and 7000 described in conjunction with FIGS. 1-13. The view 1400 illustrates an alternative nut mounting for the occupancy sensor device. In view 1400, the nut mounting direction may be adaptive to thicker ceilings.

FIG. 15 illustrates a cross-section 1500 of a side view of an occupancy sensor device with the top facing down such as the occupancy sensor devices 110, 2000, 6000, and 7000 described in conjunction with FIGS. 1-14. The view 1500 illustrates an alternative nut mounting for the occupancy sensor device. In view 1500, the nut mounting direction may be adaptive to thinner ceilings.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

### Further Embodiments

The following paragraphs describe examples of further embodiments:

Example 1 is an occupancy sensor device, comprising: a lens having a rated focal length, the lens to refract infrared radiation to converge at a point at the rated focal length; a passive infrared (PIR) sensor comprising detecting elements; and a body coupled with the lens and the PIR sensor to fix a distance between the lens and the PIR sensor, wherein the distance is between the rated focal length of the lens and the lens and the detecting elements of the PIR sensor are positioned to capture infrared radiation refracted by the lens. Example 2 is the occupancy sensor device of Example 1, wherein the PIR sensor is coupled with a first printed circuit board, the first printed circuit board coupled with a second printed circuit board, a primary plane of the second printed circuit board perpendicular to a primary plane of the first printed circuit board, the first printed circuit board coupled with the body. Example 3 is the occupancy sensor device of Example 1, wherein the lens is a multiple focal length Fresnel lens, the lens comprising additional rated focal lengths and wherein the distance differs from the additional rated focal lengths. Example 4 is the occupancy sensor device of Example 1, wherein the distance is half the rated focal length. Example 5 is the occupancy sensor device of Example 1, wherein the distance is between half the rated focal length and the rated focal length of the lens. Example 6 is the occupancy sensor device of Example 1, wherein the distance is between half the rated focal length and a quarter of the rated focal length of the lens. Example 7 is the occupancy sensor device of Example 1, wherein the distance is between half the rated focal length and three quarters of the rated focal length of the lens. Example 8 is the occupancy sensor device of Example 1, wherein the distance is between half the rated focal length and a third of the rated focal length of the lens. Example 9 is the occupancy sensor device of Example 1, wherein the distance is between half the rated focal length and two-thirds of the rated focal length of the lens. Example 10 is the occupancy sensor device of Example 1, wherein the distance is no more than 8.5 millimeters. Example 11 is the occupancy sensor device of Example 1, wherein the distance is between 7 millimeters and 8.5 millimeters. Example 12 is the occupancy sensor device of Example 1, wherein the distance is between 6 millimeters and 7 millimeters. Example 13 is the occupancy sensor device of Example 1, wherein the distance is between 7 millimeters and 8 millimeters. Example 14 is the occupancy sensor device of Example 1, the lens to converge infrared radiation refracted by the lens to an incident area at the distance, the incident area within an exposure area of the detecting elements. Example 15 is the occupancy sensor device of Example 1, the lens to converge infrared radiation refracted by the lens to an incident area at the distance, the incident area larger than an exposure area of the detecting elements. Example 16 is the occupancy sensor device of Example 1, wherein the PIR sensor comprises a quad element PIR sensor. Example 17 is the occupancy sensor device of Example 1, wherein the PIR sensor comprises a dual element PIR sensor. Example 18 is the occupancy sensor device of Example 1, wherein the PIR sensor comprises a printed circuit board comprising a communication interface configured to wirelessly transmit a packet in response to the indication of motion in accordance with a wireless communications protocol, wherein the communication interface is capable of transmitting the packet in accordance with one or more wireless communications protocols from a group of wireless communications protocols consisting of a Wi-Fi communications protocol, a Bluetooth communications protocol, a ZigBee communications protocol, a Z-Wave communications protocol; and a cellular communications protocol. Example 19 is the occupancy sensor device of Example 1, wherein the PIR sensor comprises a printed circuit board comprising a digital addressable lighting interface (DALI). Example 20 is the occupancy sensor device of Example 1, wherein the PIR sensor comprises a printed circuit board comprising a controllably conductive device coupled to the controller, the controllably conductive device arranged and configured to selectively control the ON/OFF state of an electrical load in response to the detected motion. Example 21 is the occupancy sensor device of Example 1, further comprising a housing coupled with the body, the housing to contain components of the occupancy sensor device, wherein the housing is adapted to couple with an electrical junction box. Example 22 is the occupancy sensor device of Example 1, wherein the PIR sensor comprises a printed circuit board comprising a processor to select a sensitivity for the occupancy sensor device based on a setting or a state of a switch.

Example 23 is an occupancy sensor device, comprising: a lens having a rated focal length, the lens to refract infrared radiation to converge at a point at the rated focal length; a passive infrared (PIR) sensor comprising detecting elements with an exposure area, the exposure area to capture infrared radiation incident to the exposure area; a first circuit board comprising an opening for the exposure area of the PIR sensor in a primary plane of the first circuit board; a second circuit board coupled with the PIR sensor, the second circuit board having a primary plane perpendicular to the primary plane of the first circuit board and coupled with the first circuit board to position the exposure area of the PIR sensor in the opening; and a body coupled with the lens and the PIR sensor to fix a distance between the lens and the PIR sensor, wherein the distance is less than a rated focal length of the lens and between the rated focal length of the lens and the lens and the detecting elements of the PIR sensor are positioned to capture infrared radiation refracted by the lens. Example 24 is the occupancy sensor device of Example 23, wherein the lens comprises a Fresnel lens. Example 25 is the occupancy sensor device of Example 23, wherein the PIR sensor comprises a pyroelectric sensor with pyroceramic elements. Example 26 is the occupancy sensor device of Example 23, wherein the lens is a multiple focal length Fresnel lens, the lens comprising one or more additional rated focal lengths and wherein the distance differs from the one or more additional rated focal lengths. Example 27 is the occupancy sensor device of Example 23, wherein the distance is half the rated focal length. Example 28 is the occupancy sensor device of Example 23, wherein the distance is between half the rated focal length and the rated focal length of the lens. Example 29 is the occupancy sensor device of Example 23, wherein the distance is no more than 8.5 millimeters. Example 30 is the occupancy sensor device of Example 23, wherein the distance is between 7 millimeters and 8.5 millimeters. Example 31 is the occupancy sensor device of Example 23, wherein the distance is between 6 millimeters and 7 millimeters. Example 32 is the occupancy sensor device of Example 23, wherein the distance is between 7 millimeters and 8 millimeters. Example 33 is the occupancy sensor device of Example 23, the lens to converge infrared radiation refracted by the lens to an incident area at the distance, the incident area within an exposure area of the detecting elements. Example 34 is the occupancy sensor device of Example 23, the lens to converge infrared radiation refracted by the lens to an incident area at the distance, the incident area larger than an exposure area of the detecting elements. Example 35 is the occupancy sensor device of Example 23, wherein the PIR sensor comprises a quad element PIR sensor and the exposure area comprises a 2.4 millimeter by 2.4 millimeter area. Example 36 is the occupancy sensor device of Example 23, wherein each element of the PIR sensor is 0.8 millimeter by 0.8 millimeter and the spacing between each element is 0.8 millimeter. Example 37 is the occupancy sensor device of Example 23, wherein the exposure area comprises two or more pyroceramic elements, and the exposure area is dependent on the number of pyroceramic elements. Example 38 is the occupancy sensor device of Example 23, wherein the PIR sensor comprises a printed circuit board comprising a processor to select a sensitivity for the occupancy sensor device based on a setting or a state of a switch. Example 39 is the occupancy sensor device of Example 23, further comprising a housing coupled with the body, the housing to contain components of the occupancy sensor device, wherein the housing is adapted to couple with an electrical junction box. Example 40 is the occupancy sensor device of Example 23, wherein the PIR sensor comprises a printed circuit board comprising a processor to select a sensitivity for the occupancy sensor device based on a setting or a state of a switch.

We claim:

1. An occupancy sensor device, comprising:
a lens having a rated focal length, the lens to refract infrared radiation to converge at a point at the rated focal length;
a passive infrared (PIR) sensor comprising detecting elements; and
a body coupled with the lens and the PIR sensor to fix a distance between the lens and the PIR sensor, wherein the distance is between the rated focal length of the lens and the lens and the detecting elements of the PIR sensor are positioned to capture infrared radiation refracted by the lens.

2. The occupancy sensor device of claim 1, wherein the PIR sensor is coupled with a first printed circuit board, the first printed circuit board coupled with a second printed circuit board, a primary plane of the second printed circuit board perpendicular to a primary plane of the first printed circuit board, the first printed circuit board coupled with the body.

3. The occupancy sensor device of claim 1, wherein the lens is a multiple focal length Fresnel lens, the lens comprising additional rated focal lengths and wherein the distance differs from the additional rated focal lengths.

4. The occupancy sensor device of claim 1, wherein the distance is half the rated focal length.

5. The occupancy sensor device of claim 1, wherein the distance is between half the rated focal length and the rated focal length of the lens.

6. The occupancy sensor device of claim 1, wherein the distance is between half the rated focal length and a quarter of the rated focal length of the lens.

7. The occupancy sensor device of claim 1, wherein the distance is between half the rated focal length and three quarters of the rated focal length of the lens.

8. The occupancy sensor device of claim 1, wherein the distance is between half the rated focal length and a third of the rated focal length of the lens.

9. The occupancy sensor device of claim 1, wherein the distance is between half the rated focal length and two-thirds of the rated focal length of the lens.

10. The occupancy sensor device of claim 1, wherein the distance is no greater than 8.5 millimeters.

11. The occupancy sensor device of claim 1, the lens to converge infrared radiation refracted by the lens to an incident area at the distance, the incident area within an exposure area of the detecting elements.

12. The occupancy sensor device of claim 1, the lens to converge infrared radiation refracted by the lens to an incident area at the distance, the incident area larger than an exposure area of the detecting elements.

13. The occupancy sensor device of claim 1, wherein the PIR sensor comprises at least one of a quad element PIR sensor and a dual element PIR sensor.

14. The occupancy sensor device of claim 1, wherein the PIR sensor comprises a printed circuit board comprising a digital addressable lighting interface (DALI).

15. An occupancy sensor device, comprising:
a lens having a rated focal length, the lens to refract infrared radiation to converge at a point at the rated focal length;
a passive infrared (PIR) sensor comprising detecting elements with an exposure area, the exposure area to capture infrared radiation incident to the exposure area;
a first circuit board comprising an opening for the exposure area of the PIR sensor in a primary plane of the first circuit board;
a second circuit board coupled with the PIR sensor, the second circuit board having a primary plane perpendicular to the primary plane of the first circuit board and coupled with the first circuit board to position the exposure area of the PIR sensor in the opening; and
a body coupled with the lens and the PIR sensor to fix a distance between the lens and the PIR sensor, wherein the distance is less than a rated focal length of the lens and between the rated focal length of the lens and the lens and the detecting elements of the PIR sensor are positioned to capture infrared radiation refracted by the lens.

16. The occupancy sensor device of claim 15, wherein the lens comprises a Fresnel lens.

17. The occupancy sensor device of claim 15, wherein the PIR sensor comprises a pyroelectric sensor with pyroceramic elements.

18. The occupancy sensor device of claim 15, wherein the lens is a multiple focal length Fresnel lens, the lens comprising one or more additional rated focal lengths and wherein the distance differs from the one or more additional rated focal lengths.

19. The occupancy sensor device of claim 15, wherein the distance is half the rated focal length.

20. The occupancy sensor device of claim 15, wherein the distance is no greater than 8.5 millimeters.

21. The occupancy sensor device of claim 15, the lens to converge infrared radiation refracted by the lens to an incident area at the distance, the incident area within an exposure area of the detecting elements.

22. The occupancy sensor device of claim 15, the lens to converge infrared radiation refracted by the lens to an incident area at the distance, the incident area larger than an exposure area of the detecting elements.

23. The occupancy sensor device of claim 15, wherein the PIR sensor comprises a quad element PIR sensor and the exposure area comprises a 2.4 millimeter by 2.4 millimeter area.

24. The occupancy sensor device of claim 15, wherein each element of the PIR sensor is 0.8 millimeter by 0.8 millimeter and the spacing between each element is 0.8 millimeter.

25. The occupancy sensor device of claim 15, wherein the exposure area comprises two or more pyroceramic elements, and the exposure area is dependent on the number of pyroceramic elements.
